(19) United States
(12) Patent Application Publication
(10) Pub. No.: US 2012/0019556 A1
(43) Pub. Date: Jan. 26, 2012

(54) INTERPRETATION REPORT CREATING AIDING DEVICE AND COMPUTER-READABLE STORAGE MEDIUM STORING A PROGRAM THEREFOR

(75) Inventor: Akira Kurahashi, Tokyo (JP)

(73) Assignee: Konica Minolta Medical & Graphics, Inc., Tokyo (JP)

(21) Appl. No.: 13/260,526

(22) PCT Filed: Mar. 2, 2010
(86) PCT No.: PCT/JP2010/053302

§ 371 Date: Sep. 26, 2011

(30) Foreign Application Priority Data
Mar. 26, 2009 (JP) 2009-076536

(51) Int. Cl. G09G 5/00

(52) U.S. Cl. 345/629

(57) ABSTRACT

An interpretation report creation aiding device includes a display unit and a control unit which displays an interpretation report creation screen on the display unit. In the interpretation report creation screen, a right breast image and a left breast image to be interpreted are disposed in a central region thereof in such a way as to be bilaterally symmetrical, and an interpretation report writing region for writing an interpretation report on the right breast image and an interpretation report writing region for writing an interpretation report on the left breast image are respectively disposed in regions respectively adjacent to the right breast image and the left breast image.

### FIELD OF THE INVENTION

The present invention relates to an interpretation report creation aiding device and a program therefor.

### BACKGROUND OF THE ART

At a medical facility such as a hospital or a clinic, a breast of a patient is photographed by using a breast image photographic device (modality) or the like to generate a breast image (breast image data). A radiologist displays the generated breast image on an interpretation screen, and creates an interpretation report on the breast image on a report generation screen (interpretation report creation screen).

As a system to create an interpretation report, for example, a medical image processing system is disclosed by Japanese Patent Application Laid-open Publication No. 2006-51198, the medical image processing system including an image quality inspection terminal into which an additional imaging determining section is incorporated. The additional imaging determining section performs a predetermined image analysis on image data generated by an image generation unit so as to objectively determine the necessity of additional imaging or the like and the type thereof.

### RELATED ART DOCUMENT

### Patent Document

Patent Document 1: Japanese Patent Application Laid-open Publication No. 2006-51198

### SUMMARY OF THE INVENTION

### The Problems to be Solved by the Invention

On the report generation screen, the breast image displayed on the interpretation screen is displayed as an attached image. In the interpretation report on the breast image, the position of a lesion in the breast image is needed to be correlated with a comment (interpretation report) on the lesion.

However, conventionally, in the interpretation report on the breast image, the breast image is displayed small at a lower part of the report generation screen, and hence it is difficult to know where the lesion is, and it is inconvenient for a doctor (user) to refer to (look at) the interpretation report.

The present invention is made in view of the circumstances, and an object of the present invention is to make it easy for a user to view an interpretation report on a breast image.

### Means for Solving the Problems

To solve the problems mentioned above, the present invention disclosed by claim 1 is an interpretation report creation aiding device including: a display unit; and a control unit which displays an interpretation report creation screen on the display unit, the interpretation report creation screen wherein a right breast image and a left breast image to be interpreted are disposed in a central region in such a way as to be bilaterally symmetrical, and an interpretation report writing region for writing an interpretation report on the right breast image and an interpretation repost writing region for writing an interpretation report on the left breast image are respectively disposed in regions respectively adjacent to the right breast image and the left breast image.

According to the present invention disclosed by claim 2, in the present invention disclosed by claim 1, each of the breast images is a schema image.

According to the present invention disclosed by claim 3, in the present invention disclosed by claim 1, each of the breast images is an attached-to-report image.

According to the present invention disclosed by claim 4, in the present invention disclosed by any one of claims 1 to 3, the present invention further includes an input unit with which information on the interpretation reports is input, wherein the control unit controls the display unit to display the interpretation reports in the interpretation report writing regions based on the information on the interpretation reports inputted with the input unit.

According to the present invention disclosed by claim 5, in the present invention disclosed by claim 4, the information on the interpretation reports is inputted with the input unit by handwriting input, and the control unit controls the display unit to display the interpretation reports in the interpretation report writing regions by handwriting display.

According to the present invention disclosed by claim 6, in the present invention disclosed by claim 4, the information on the interpretation reports is inputted with the input unit by text input, and the control unit controls the display unit to display the interpretation reports in the interpretation report writing regions by text display.

The present invention disclosed by claim 7 is a program for making a computer execute functions of: a display unit; and a control unit which displays an interpretation report creation screen on the display unit, the interpretation report creation screen wherein a right breast image and a left breast image to be interpreted are disposed in a central region in such a way as to be bilaterally symmetrical, and an interpretation report writing region for writing an interpretation report on the right breast image and an interpretation repost writing region for writing an interpretation report on the left breast image are respectively disposed in regions respectively adjacent to the right breast image and the left breast image.

### Advantageous Effects of the Invention

According to the present invention disclosed by claim 1 and claim 7, in a central region of an interpretation report creation screen, a right breast image and a left breast image to be interpreted are disposed in such away as to be bilaterally symmetrical. In addition, an interpretation report writing region for writing an interpretation report on the right breast image and an interpretation repost writing region for writing an interpretation report on the left breast image are respectively disposed in regions respectively adjacent to the right breast image and the left breast image.

Accordingly, it can be easy for a user to view an interpretation report on a breast image.

According to the present invention disclosed by claim 2, a user can refer to an interpretation report to which a schema image is attached. Accordingly, it can be easier for a user to view an interpretation report on a breast image.

According to the present invention disclosed by claim 3, a user can refer to an interpretation report to which an attached-to-report image is attached. Accordingly, it can be easier for a user to view an interpretation report on a breast image.

According to the present invention disclosed by claim 4, the convenience in generating an interpretation report on a breast image can be increased.

According to the present invention disclosed in claim 5, the convenience in generating an interpretation report on a breast image can be further increased. Furthermore, it can be easier for a user to view an interpretation report on a breast image.

According to the present invention disclosed by claim 6, the convenience in generating an interpretation report on a breast image can be further increased. Furthermore, it can be easier for a user to view an interpretation report on a breast image.

### BRIEF DESCRIPTION OF THE DRAWINGS

FIG. 1 is a block diagram showing an example of a system configuration of a radiology system;

FIG. 2 is a block diagram showing a data configuration of a breast image data object;

FIG. 3 is a block diagram of an image viewer terminal;

FIG. 4 is a block diagram of a report generation management device;

FIG. 5 is an image view showing a relationship between interpretation reports and breast images in a mammogram examination;

FIG. 6 is a block diagram showing a data model of an interpretation report in a mammogram examination;

FIG. 7 is a block diagram showing a data configuration of an interpretation report data object;

FIG. 8 is a flowchart showing specific operations performed by the report generation management device and the image viewer terminal;

FIG. 9 shows an example of a report generation screen; and

FIG. 10 shows another example of the report generation screen.

### BEST MODE FOR CARRYING OUT THE INVENTION

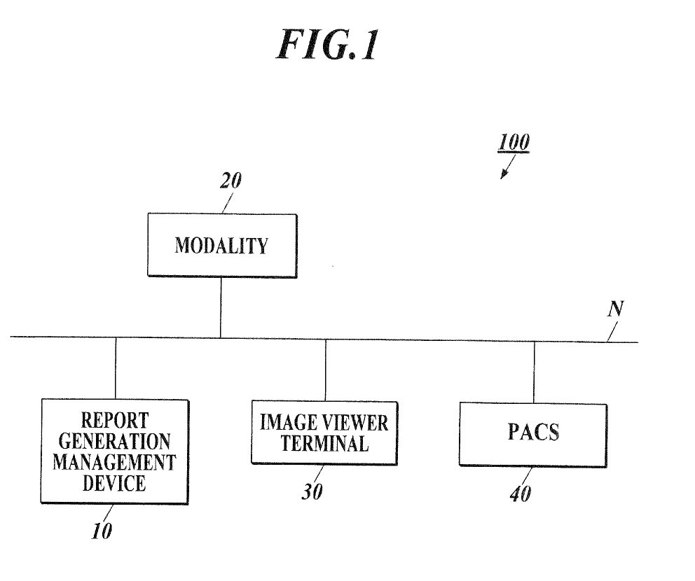

In the following, an embodiment in which an interpretation report creation aiding device of the present invention is applied to a report generation management device 10 shown in FIG. 1 is described referring to FIGS. 1 to 9.

### System Configuration of Radiology System

First, a radiology system 100 including the report generation management device 10 is described in summary referring to FIG. 1.

FIG. 1 is a block diagram showing an example of a system configuration of the radiology system 100. As shown in FIG. 1, the radiology system 100 includes the report generation management device 10, a modality 20, an image viewer terminal 30, and a PACS (Picture Archiving and Communication System) 40. The components are connected with each other via a communication network N such as a LAN (Local Area Network) so as to perform data communications.

The modality 20 is a breast photographic device by which a breast of a patient is photographed, thereby generating image data (actual image data) of a taken image (breast image). In the following, an examination performed by the breast photographic device is referred to as a mammogram examination.

The modality 20 receives order information from a not-shown RIS (Radiation Information System). The RIS is a system which manages information in the radiology system 100 as a whole. The order information is data showing contents of an examination order for photography or a diagnosis.

The modality 20 generates supplementary information including various kinds of information (patient information, examination information, series information, and the like) on the actual image data of the generated breast image, based on the order information received from the RIS. Then, the modality 20 attaches the supplementary information to the actual image data, and generates breast image data complying with the DICOM (Digital Imaging and COmmunication in Medicine) standard. The modality 20 sends the generated breast image data to the PACS 40.

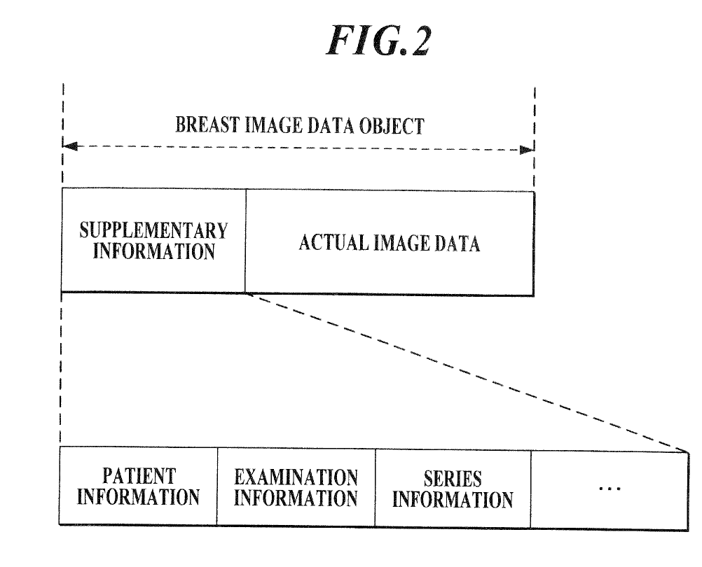

FIG. 2 shows a data configuration of breast image data for one breast image (a breast image data object, hereinbelow). As described above, a breast image data object is constituted of actual image data for one breast image and supplementary information on the actual image data. The supplementary information includes patient information, examination information, and series information. The examination information includes items of “photography part”, “photography direction”, and “image side/image laterality”.

As shown in FIG. 1, the PACS 40 is a database system which saves and manages the breast image data generated in the modality 20, and performs a search and a data analysis. The PACS 40 includes a control unit, a storage unit, and a communication unit, and accumulates and stores the breast image data in a relational database or the like based on the supplementary information included in the breast image data received from the modality 20. Then, the PACS 40 searches for breast image data by using a patient ID, an examination ID or the like as a search key which is specified in accordance with an operation command of a radiologist or the like, and outputs the breast image data to the image viewer terminal 30 or a not-shown imager. In addition, when receiving a breast image data obtaining request including a search key such as a patient ID or an examination ID from an external device, the PACS 40 searches for breast image data matching the obtaining request, and supplies (sends) the breast image data to the external device.

The image viewer terminal 30 has a viewer function to display breast image data, and serves a radiologist or the like when the radiologist or the like performs interpretation on the breast image data. The image viewer terminal 30 sends a breast image data obtaining request to the PACS 40, and obtains breast image data matching the obtaining request from the PACS 40. Then, the image viewer terminal 30 displays the obtained breast image data. In addition, the image viewer terminal 30 sends the obtained breast image data to the report generation management device 10.

The report generation management device 10 has a report generation function to generate an interpretation report on breast image data and a report management function to manage the generated interpretation report. The report generation management device 10 displays a report generation screen (interpretation report creation screen) 131 based on the breast image data received from the image viewer terminal 30. The report generation management device 10 generates an interpretation report (interpretation report data) based on an operation command of a radiologist or the like. The report generation management device 10 saves and manages the generated interpretation report.

### Functional Configuration of Image Viewer Terminal

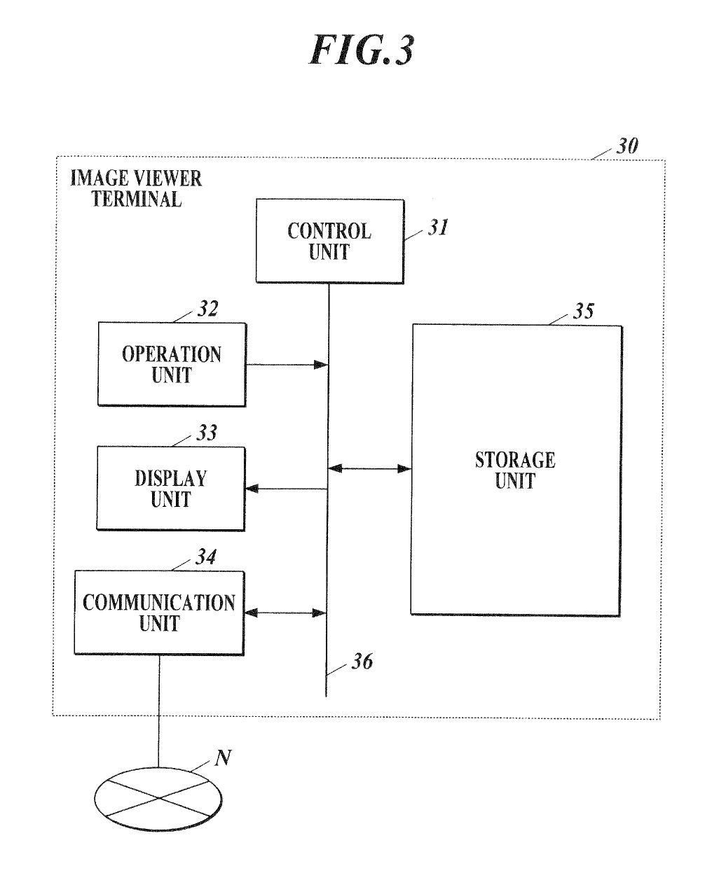

FIG. 3 shows a functional configuration of the image viewer terminal 30.

As shown in FIG. 3, the image viewer terminal 30 includes a control unit 31, an operation unit 32, a display unit 33, a communication unit 34, and a storage unit 35. The components are connected with each other by a bus 36.

The control unit 31 includes a CPU (Central Processing Unit) and a RAM (Random Access Memory), and controls process operations of the components of the image viewer terminals 30 as a whole. More specifically, the CPU reads a process program of various process programs stored in the storage unit 35 in accordance with an operation signal inputted from the operation unit 32 or a command signal received by the communication unit 34, expands the read program in a work area formed in the RAM, and performs a process by working in cooperation with the program.

The operation unit 32 is constituted of a keyboard including cursor keys, number input keys, and various function keys, and a pointing device such as a mouse. The operation unit 32 outputs an operation signal to the control unit 31, the operation signal which is inputted by a key operation onto the keyboard or a mouse operation.

The display unit 33 is constituted of a high definition LCD (Liquid Crystal Display), and displays various screens based on display data inputted from the control unit 31.

The communication unit 34 includes a LAN (Local Area Network) adaptor, a router, and a TA (Terminal Adapter), and sends/receives data to/from external devices such as the report generation management device 10 and the PACS 40 via the communication network N.

The storage unit 35 is constituted of a hard disk or the like, and stores a control program and parameters, files, and the like necessary for executing the program.

When receiving an image display command from the report generation management device 10 via the communication unit 34, the control unit 31 generates a breast image data obtaining request based on the image display command. Then, the control unit 31 sends the generated breast image data obtaining request to the PACS 40 via the communication unit 34.

When obtaining breast image data matching the breast image data obtaining request from the PACS 40 via the communication unit 34, the control unit 31 transfers the breast image data to the report generation management device 10. In addition, the control unit 31 displays, on the display unit 33, a breast image and supplementary information thereon based on the obtained breast image data.

### Functional Configuration of Report Generation Management Device

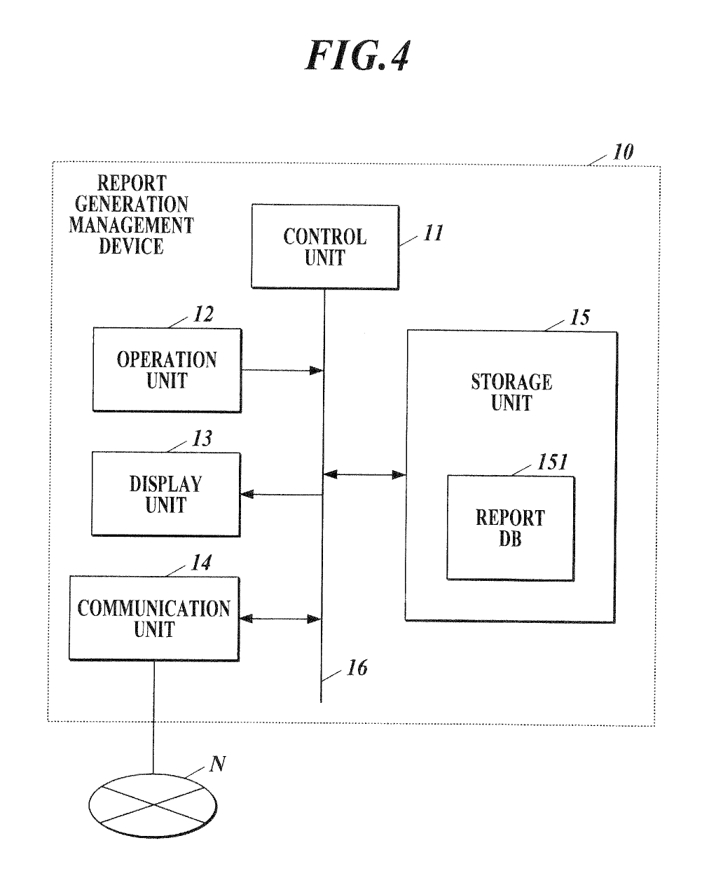

FIG. 4 shows a functional configuration of the report generation management device 10.

As shown in FIG. 4, the report generation management device 10 includes a control unit 11, an operation unit 12, a display unit 13, a communication unit 14, and a storage unit 15. The components are connected with each other by a bus 16.

The control unit 11 includes a CPU and a RAM, and controls process operations of the components of the report generation management device 10 as a whole. More specifically, the CPU reads a process program of various process programs stored in the storage unit 15 in accordance with an operation signal inputted from the operation unit 12 or a command signal received by the communication unit 14, expands the read program in a work area formed in the RAM, and performs a process by working in cooperation with the program.

The operation unit 12 is constituted of a keyboard including cursor keys, number input keys, and various function keys, and a pointing device such as a mouse. The operation unit 12 outputs an operation signal to the control unit 11, the operation signal which is inputted by a key operation onto the keyboard or a mouse operation.

The display unit 13 is constituted of an LCD, and displays various screens based on display data inputted from the control unit 11.

The communication unit 14 includes a LAN adaptor, a router, and a TA, and sends/receives data to/from an external device such as the image viewer terminal 30 via the communication network N.

The storage unit 15 is constituted of a hard disk or the like, and stores a control program and parameters, files, and the like necessary for executing the program. The storage unit 15 stores a report DB (DataBase) 151. The report DB 151 is a database to store and manage interpretation report data.

When obtaining breast image data from the image viewer terminal 30 via the communication unit 14, the control unit 11 generates an attached-to-report image based on the breast image data. The control unit 11 generates a report generation screen 131 to which the attached-to-report image is attached, and displays the report generation screen 131 on the display unit 13.

Then, the control unit 11 generates interpretation report data based on an operation signal from the operation unit 32 or the like, the operation signal generated when a user performs an operation on the report generation screen 131. The control unit 11 stores and manages the generated interpretation report data in the report DB 151 of the storage unit 15.

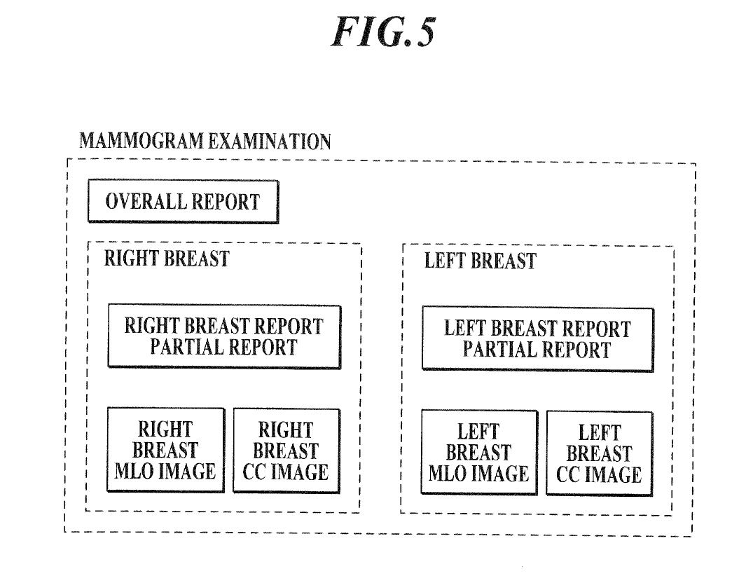

FIG. 5 is an image view showing a relationship between interpretation reports and breast images in a mammogram examination. As shown in FIG. 5, a mammogram examination is constituted of a right breast examination and a left breast examination.

In the right breast examination, a breast image (right breast MLO image) taken from MLO (MedioLateral-Oblique direction) and a breast image (right breast CC image) taken from CC (Cranial-Caudal direction) are generated in the modality 20. Also, an interpretation report on the right breast MLO image and the right breast CC image is generated. The right breast report is a partial report. The partial report is described below.

Similarly, in the left breast examination, a breast image (left breast MLO image) taken from MLO (MedioLateral-Oblique direction) and a breast image (left breast CC image) taken from CC (Cranial-Caudal direction) are generated in the modality 20. Also, an interpretation report on the left breast MLO image and the left breast CC image is generated. The left breast report is a partial report.

In the mammogram examination, an interpretation report (overall report) in which the right breast report and the left breast report are comprehensively assessed is generated.

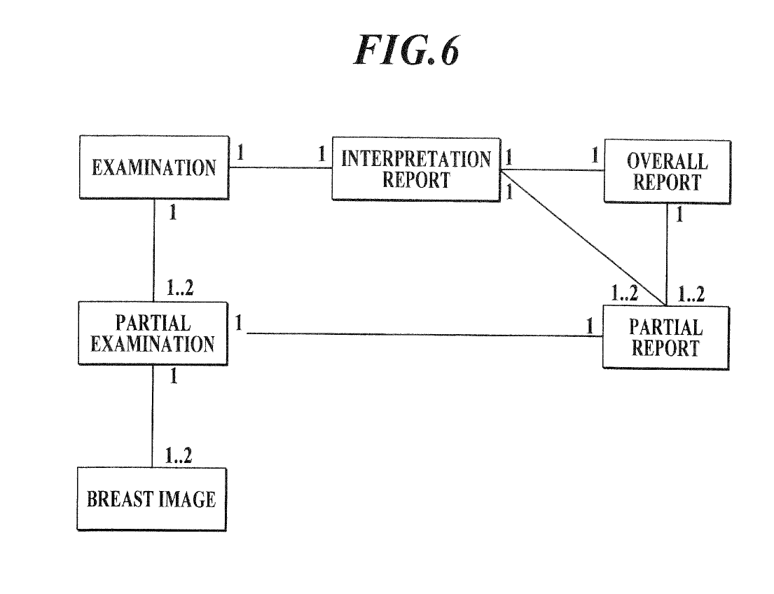

FIG. 6 is a block diagram showing a data model of an interpretation report (interpretation report data) in a mammogram examination. In the report DB 151, examinations, interpretation reports, breast images, and the like are correlated in accordance with this data model. As shown in FIG. 6, in a mammogram examination, an interpretation report is generated for each examination. Interpretation report data for one examination is referred to as an interpretation report data object.

As described above, a mammogram examination includes two partial examinations. More specifically, the two partial examinations are a right breast examination and a left breast examination. In each partial examination, medial image data for two breast images, namely, two breast image data objects, are generated. More specifically, one of the two breast image data objects is data corresponding to the breast image taken from MLO in the modality 20 (the right breast MLO image or the left breast MLO image), and the other thereof is data corresponding to the breast image taken from CC therein (the right breast CC image or the left breast CC image).

In an interpretation report for one examination, two partial reports and one overall report are included. A partial report is an interpretation report for a partial examination. That is, an interpretation report for one examination includes a partial interpretation report for the right breast examination (right breast report) and a partial interpretation report for the left breast examination (left breast report). The overall report is an interpretation report (overall report) in which the partial examinations are comprehensively assessed. That is, an interpretation report for one examination includes an overall interpretation report in which the right breast examination and the left breast examination are comprehensively assessed. Data of a partial report for one partial examination is referred to as a partial report data object, and data of one overall report is referred to as an overall report data object.

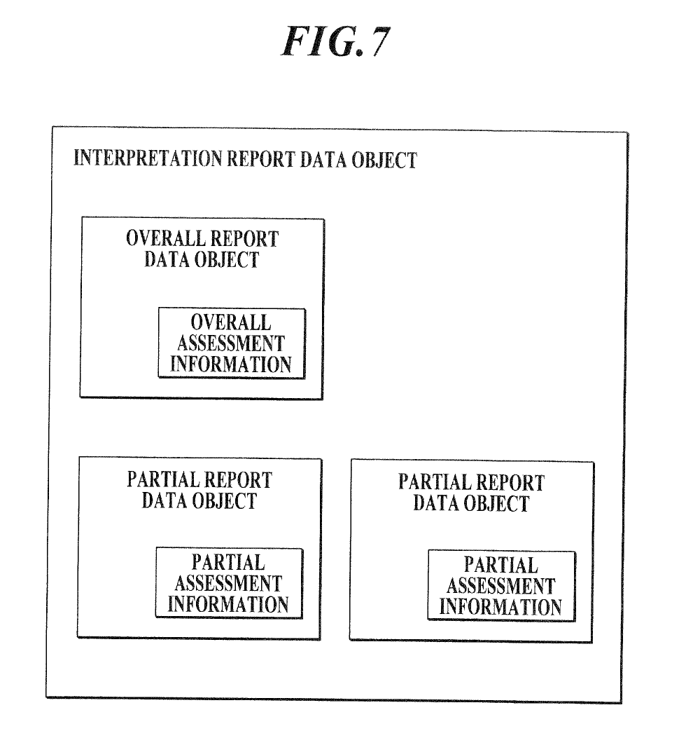

FIG. 7 is a block diagram showing a data configuration of an interpretation report data object stored and managed by the report DB 151. As shown in FIG. 7, an interpretation report data object includes one overall report data object and two partial report data objects. Each of the partial report data objects includes partial assessment information. The overall report data object includes overall assessment information. In the report DB 151, one interpretation report data object or a plurality of interpretation report data objects is stored.

### Specific Operation of Report Generation Management Device or the Like

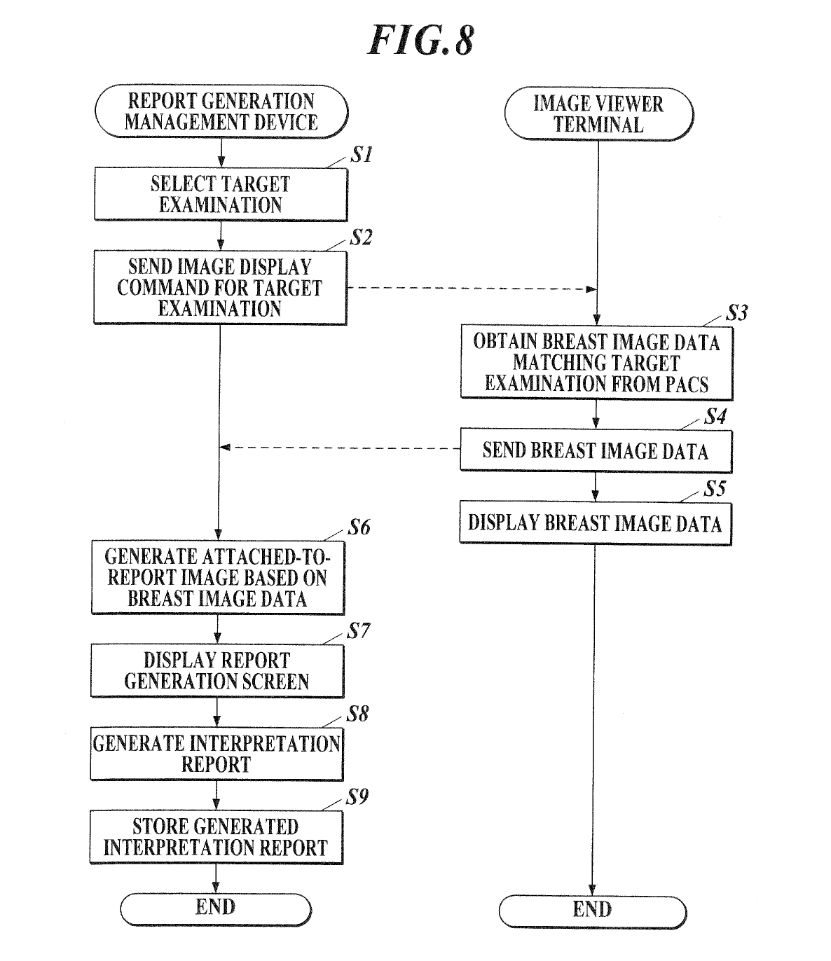

Next, specific operations performed by the report generation management device 10 and the image viewer terminal 30 are described referring to FIG. 8.

A user operates the operation unit 12 of the report generation management device 10 to select an examination for which an interpretation report is generated (interpretation work). Accordingly, the control unit 11 selects a target examination for which an interpretation report is generated, based on an operation signal from the operation unit 12 (Step S1).

Then, the control unit 11 generates an image display command including an examination ID of the examination selected at Step S1, a patient ID of a patient undergoing the examination, and the like. The control unit 11 sends the generated image display command to the image viewer terminal 30 via the communication unit 14 (Step S2).

When receiving (obtaining) the image display command from the report generation management device 10 via the communication unit 34, the control unit 31 of the image viewer terminal 30 obtains breast image data matching the examination, for which an interpretation report is generated, from the PACS 40 (Step S3). More specifically, the control unit 31 uses the patient ID or the examination ID included in the obtained image display command as a search key. The control unit 31 generates a breast image data obtaining request including the search key. The control unit 31 sends the generated breast image data obtaining request to the PACS 40 via the communication unit 34. Then, the control unit 31 receives breast image data corresponding to the obtaining request from the PACS 40 via the communication unit 34. The breast image data corresponding to the obtaining request are four medial image data objects respectively corresponding to a right breast MLO image, a right breast CC image, a left breast MLO image, and a left breast CC image.

The control unit 31 sends the breast image data (four breast image data objects) obtained from the PACS 40 to the report generation management device 10 via the communication unit 34 (Step S4).

Then, the control unit 31 displays the medial image data obtained from the PACS 40 on the display unit 33 (Step S5). More specifically, the control unit 31 displays the right breast MLO image, the right breast CC image, the left breast MLO image, and the left breast CC image, and supplementary information on each of the four images on a high definition monitor. A radiologist performs the interpretation work referring to the images displayed on the high definition monitor.

On the other hand, when receiving the breast image data from the image viewer terminal 30 via the communication unit 14, the control unit 11 of the report generation management device 10 generates attached-to-report images (attached-to-report image data) based on the breast image data (Step S6). More specifically, the control unit 11 performs a size change process and the like on the actual image data (actual image data included in the breast image data), the size change process by which the size of the actual image data is changed so that the breast image data can be attached to the interpretation report, thereby generating the attached-to-report image data suitable to be displayed on a report generation screen 131.

Then, the control unit 11 displays, on the display unit 13, the report generation screen 131 to which the attached-to-report image data is attached (Step S7). The report generation screen 131 is described below.

A user creates an interpretation report on the report generation screen 131. The control unit 11 generates an interpretation report data object based on, for example, an operation signal from the operation unit 12 operated by the user (Step S8).

The control unit 11 stores (saves) the generated interpretation report data object in the report DB 151 of the storage unit 15 (Step S9). Thus, the operations end.

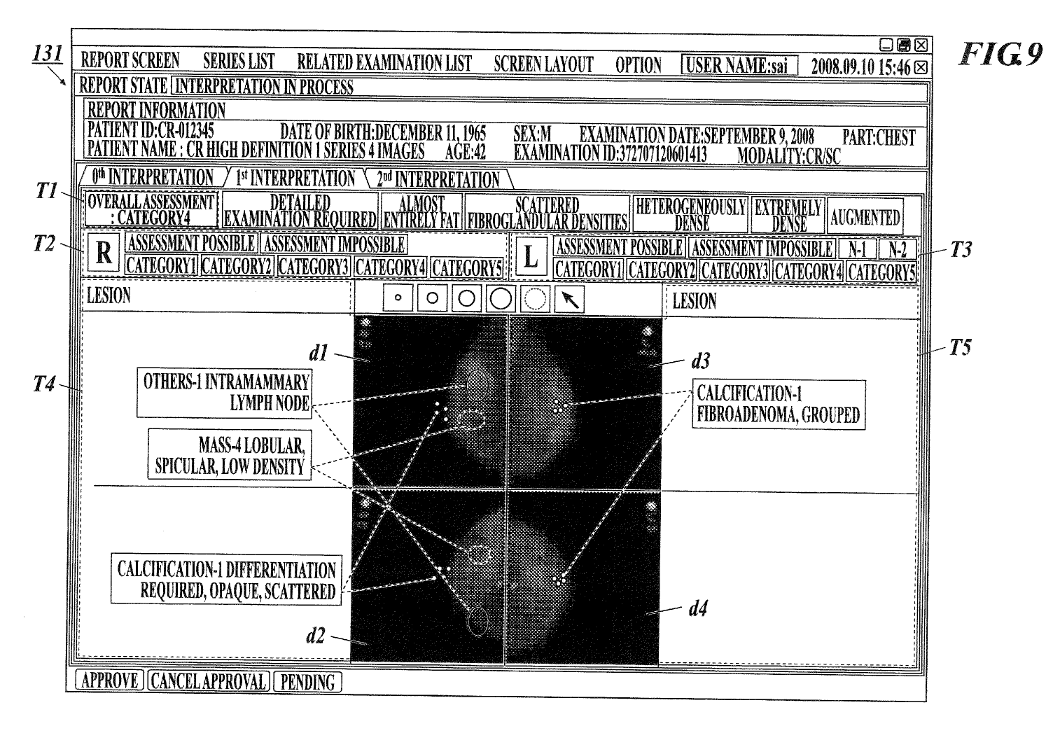

FIG. 9 shows an example of the report generation screen 131. As shown in FIG. 9, the report generation screen 131 is constituted of an overall assessment display region T1, a right breast partial assessment setting region T2, a left breast partial assessment setting region T3, a right breast report writing region T4, a left breast report writing region T5, and the like. The right breast report writing region T4 includes attached-to-report images d1 and d2. The left breast report writing region T5 includes attached-to-report images d3 and d4.

The attached-to-report image d1 is a right breast MLO image, and the attached-to-report image d2 is a right breast CC image. The attached-to-report image d3 is a left breast MLO image, and the attached-to-report image d4 is a left breast CC image.

The right breast report writing region T4 is a region to write a right breast report. A user writes a partial report in the right breast report writing region T4 via the operation unit 12. More specifically, a user operates the keyboard of the operation unit 12 so as to write the report in a text form. Accordingly, the operation unit 12 inputs an operation signal for text input to the control unit 11. The control unit 11 displays information on the interpretation report (right breast partial report) in the right breast report writing region T4 in the text form (by text display) based on the operation signal for the text input.

The right breast partial assessment setting region T2 is a region to make a partial assessment of the right breast report. A user selects buttons from the category buttons 1 to 5 and the like arranged in the right breast partial assessment setting region T2 via the operation unit 12, thereby making the partial assessment of the right breast report. When abnormalities are not found, the category 1 is selected. When there is a finding which can be surely diagnosed as benign, the category 2 is selected. When there is a finding which should be benign but the possibility of being malignant cannot be denied, the category 3 is selected. When there is a finding which is suspected of being malignant, the category 4 is selected. When there is a finding which is malignant, the category 5 is selected. That is, the larger the number of the category becomes (from the category 1 to the category 5), the worse the diagnosis result is.

The left breast report writing region T5 is a region to write a left breast report. A user writes a partial report in the left breast report writing region T5 via the operation unit 12. More specifically, a user operates the keyboard of the operation unit 12 so as to write the report in a text form. Accordingly, the operation unit 12 inputs an operation signal for text input to the control unit 11. The control unit 11 displays information on the interpretation report (left breast partial report) in the left breast report writing region T5 in the text form (by text display) based on the operation signal for the text input.

The left breast partial assessment setting region T3 is a region to make a partial assessment of the left breast report. A user selects buttons from category buttons 1 to 5 and the like arranged in the left breast partial assessment setting region T3 via the operation unit 12, thereby making the partial assessment of the left breast report.

The overall assessment display region T1 is a region to make an overall assessment of the partial examinations.

Thus, in a central region of the report generation screen 131, the attached-to-report images (breast images) d1-d2 and d3-d4 to be interpreted are arranged in such a way as to be bilaterally symmetrical. Each of the regions (the right breast report writing region T4 except for the regions of the attached-to-report images d1 and d2 and the left breast report writing region T5 except for the regions of the attached-to-report images d3 and d4) respectively adjacent to the attached-to-report images d1-d2 and d3-d4 is a report writing region to write an interpretation report (partial report) on a breast image.

On the report generation screen 131, a not-shown report generation button is displayed. When the report generation button is depressed, an interpretation report data object is generated, and saved in the report DB 151.

At the time, the right breast report written in the right breast report writing region T4 makes a value of the right breast partial report data object of the interpretation report data object. In addition, the partial assessment set in the right breast partial assessment setting region T2 makes the partial assessment information on the right breast partial report data object.

Also, the left breast report written in the left breast report writing region T5 makes a value of the left breast partial report data object of the interpretation report data object. In addition, the partial assessment set in the left breast partial assessment setting region T3 makes the partial assessment information on the left breast partial report data object.

Also, the overall assessment set in the overall assessment display region T1 makes a value of the overall report data object of the interpretation report data object.

### Modification

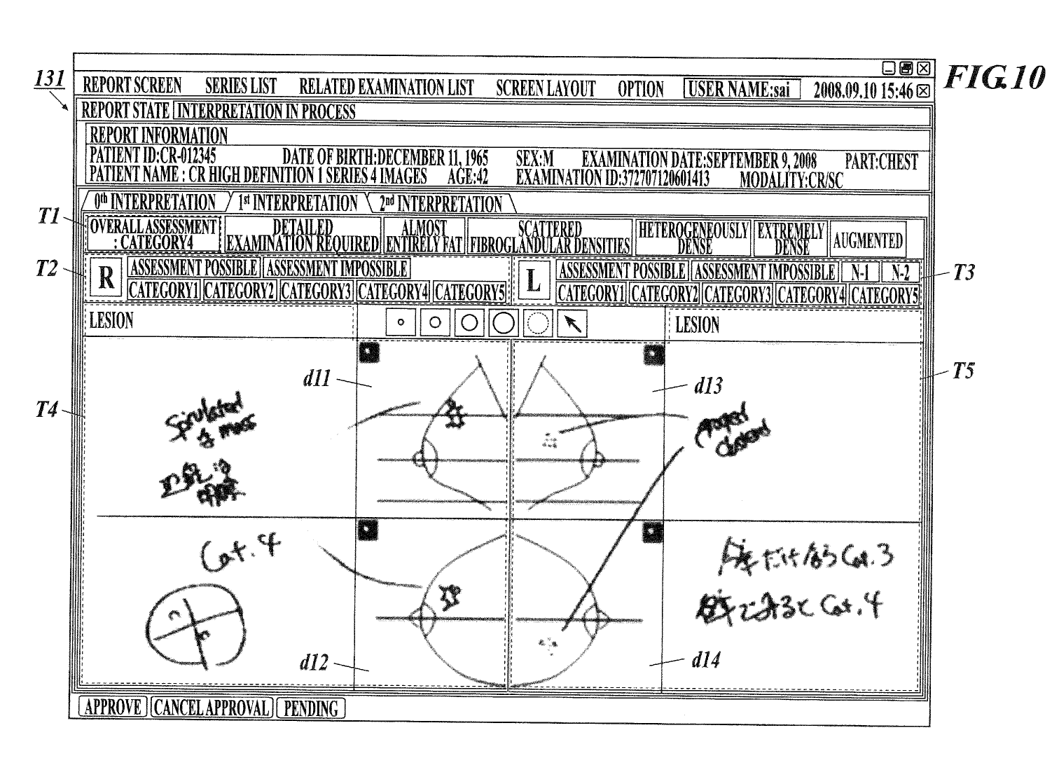

Next, a modification of the embodiment, the modification in which the interpretation report creation aiding device of the present invention is applied to the report generation management device 10 shown in FIG. 1, is described referring to FIG. 10. The modification is mainly described from the points different from the embodiment.

In the embodiment described above, the attached-to-report images are displayed in the region at the center (central region) of the report generation screen 131. In the modification, schema images are displayed in the region at the center of the report generation screen 131.

Furthermore, in the embodiment, the partial reports are written in the right breast report writing region T4 and the left breast report writing region T5 of the report generation screen 131 by the text input. In the modification, the partial reports are written by handwriting input instead of the text input.

### Functional Configuration of Report Generation Management Device

The operation unit 12 of the report generation management device 10 includes a pen tablet for the handwriting input. The operation unit 12 detects a trace of a letter, a figure, or the like inputted in a tablet main body of the pen tablet with an input pen dedicated thereto, the tablet main body which is constituted of a liquid crystal panel and a sensor substrate, and outputs a detection signal to the control unit 11.

The storage unit 15 stores a template of a schema image of a breast (schema image, hereinbelow). More specifically, the storage unit 15 stores a schema image of the right breast MLO image, a schema image of the right breast CC image, a schema image of the left breast MLO image, and a schema image of the left breast CC image.

### Specific Operation of Report Generation Management Device or the Like

Next, specific operations performed by the report generation management device 10 and the image viewer terminal 30 are described. The modification is different from the embodiment in Steps 6 and 7 shown in FIG. 8.

At Step S6 shown in FIG. 8, when receiving the breast image data from the image viewer terminal 30 via the communication unit 14, the control unit 11 of the report generation management device 10 reads schema images from the storage unit 15. More specifically, the control unit 11 reads the schema image of the right breast MLO image, the schema image of the right breast CC image, the schema image of the left breast MLO image, and the schema image of the left breast CC image from the storage unit 15.

At Step S7, the control unit 11 displays the report generation screen 131 to which the read schema images are attached based on the supplementary information on the received breast image data or the like.

### Report Generation Screen

FIG. 10 shows another example of the report generation screen 131. As shown in FIG. 10, the report generation screen 131 is constituted of an overall assessment display region T1, a right breast partial assessment setting region T2, a left breast partial assessment setting region T3, a right breast report writing region T4, a left breast report writing region T5, and the like. The right breast report writing region T4 includes schema images d11 and d12. The left breast report writing region T5 includes schema images d13 and d14.

The schema image d11 is a schema image of a right breast MLO image, and the schema image d12 is a schema image of a right breast CC image. The schema image d13 is a schema image of a left breast MLO image, and the schema image d14 is a schema image of a left breast CC image.

The right breast report writing region T4 is a region to write a right breast report. A user writes a partial report in the right breast report writing region T4 via the operation unit 12. More specifically, a user operates the pen tablet of the operation unit 12 so as to write the report in a handwriting form. Accordingly, the operation unit 12 inputs an operation signal for handwriting input to the control unit 11. The control unit 11 displays information on the interpretation report (right breast partial report) in the right breast report writing region T4 in the handwriting form (by handwriting display) based on the operation signal for the handwriting input.

The right breast partial assessment setting region T2 is a region to make a partial assessment of the right breast report. A user selects buttons from the category buttons 1 to 5 and the like arranged in the right breast partial assessment setting region T2 via the operation unit 12, thereby making the partial assessment of the right breast report.

The left breast report writing region T5 is a region to write a left breast report. A user writes a partial report in the left breast report writing region T5 via the operation unit 12. More specifically, a user operates the pen tablet of the operation unit 12 so as to write the report in a handwriting form. Accordingly, the operation unit 12 inputs an operation signal for handwriting input to the control unit 11. The control unit 11 displays information on the interpretation report (left breast partial report) in the left breast report writing region T5 in the handwriting form (by handwriting display) based on the operation signal for the handwriting input.

The left breast partial assessment setting region T3 is a region to make a partial assessment of the left breast report. A user selects buttons from category buttons 1 to 5 and the like arranged in the left breast partial assessment setting region T3 via the operation unit 12, thereby making the partial assessment of the left breast report.

The overall assessment display region T1 is a region to make an overall assessment of the partial examinations.

As described above, according to the embodiment, in the central region of the report generation screen (interpretation report creation screen) 131 displayed on the display unit 13 by the control unit 11 of the report generation management device 10, the right and left breast images (attached-to-report images d1-d2 and d3-d4) to be interpreted are arranged in such a way as to be bilaterally symmetrical. Furthermore, each of the regions respectively adjacent to the attached-to-report images d1-d2 and d3-d4 (the right breast report writing region T4 except for the regions of the attached-to-report images d1 and d2, and the left breast report writing region T5 except for the regions of the attached-to-report images d3 and d4) forms a report writing region to write an interpretation report on a breast image (partial report).

Accordingly, a user can display the position of a lesion in a breast image in such away as to be correlated with a comment (interpretation report) on the lesion on the report generation screen 131. Accordingly, it can be easy for a user to view an interpretation report on a breast image.

The embodiment is an example of the interpretation report creation aiding device of the present invention. Hence, the present invention is not limited to the embodiment. Also, the detailed configurations and detailed operations of the system and the devices can be appropriately modified.

For example, in the embodiment, the image viewer terminal 30 and the PACS 40 are separate devices. However, the image viewer terminal 30 and the PACS 40 may be integrated into one device. Furthermore, in the embodiment, the report generation management device 10 and the image viewer terminal 30 are separate devices. However, the report generation management device 10 and the image viewer terminal 30 may be integrated into one device.

Furthermore, it is possible that the attached-to-report images are displayed in the region at the center (central region) of the report generation screen 131, and the partial reports are written in the right breast report writing region T4 and the left breast report writing region T5 of the report generation screen 131 by the handwriting input. Furthermore, it is possible that the schema images are displayed in the region at the center (central region) of the report generation screen 131, and the partial reports are written in the right breast report writing region T4 and the left breast report writing region T5 of the report generation screen 131 by the text input.

Furthermore, in the embodiment, as a computer readable medium which stores a program, a hard disk is used. However, this is not a limit. As the computer readable medium, a portable storage medium such as a CD-ROM, a non-volatile memory such as a flush memory, or the like can be used. Furthermore, as a medium which provides data of the program via a communication line, a carrier wave may be used.

### INDUSTRIAL APPLICABILITY

The present invention can be used in the field of medical services, and can be applied to an interpretation report creation aiding device in a radiology system.

### EXPLANATION OF REFERENCES

10 report generation management device

11 control unit

12 operation unit

13 display unit

14 communication unit

15 storage unit

16 bus

20 modality

30 image viewer terminal

31 control unit

32 operation unit

33 display unit

34 communication unit

35 storage unit

36 bus

40 PACS

100 radiology system

151 report DB

N network

T1 overall judgment display region

T2 right breast partial judgment setting region

T3 left breast partial judgment setting region

T4 right breast report making region

T5 left breast report making region

1. An interpretation report creation aiding device comprising:
a display unit; and
a control unit which displays an interpretation report creation screen on the display unit, in which interpretation report creation screen a right breast image and a left breast image to be interpreted are disposed in a central region thereof in such a way as to be bilaterally symmetrical, and an interpretation report writing region for writing an interpretation report on the right breast image and an interpretation report writing region for writing an interpretation report on the left breast image are respectively disposed in regions respectively adjacent to the right breast image and the left breast image.

2. The interpretation report creation aiding device according to claim 1, wherein each of the breast images is a schema image.

3. The interpretation report creation aiding device according to claim 1, wherein each of the breast images is an attached-to-report image.

4. The interpretation report creation aiding device according to claim 1, further comprising:
an input unit with which information on the interpretation reports is input,
wherein the control unit controls the display unit to display the interpretation reports in the interpretation report writing regions based on the information on the interpretation reports inputted with the input unit.

5. The interpretation report creation aiding device according to claim 4, wherein:
the information on the interpretation reports is inputted with the input unit by handwriting input, and
the control unit controls the display unit to display the interpretation reports in the interpretation report writing regions by handwriting display.

6. The interpretation report creation aiding device according to claim 4, wherein:
the information on the interpretation reports is inputted with the input unit by text input, and
the control unit controls the display unit to display the interpretation reports in the interpretation report writing regions by text display.

7. A non-transitory computer-readable storage medium having a program stored thereon for controlling a computer to function as units comprising:
a display unit; and
a control unit which displays an interpretation report creation screen on the display unit, in which interpretation report creation screen a right breast image and a left breast image to be interpreted are disposed in a central region thereof in such a way as to be bilaterally symmetrical, and an interpretation report writing region for writing an interpretation report on the right breast image and an interpretation report writing region for writing an interpretation report on the left breast image are respectively disposed in regions respectively adjacent to the right breast image and the left breast image.
